(19) United States
(12) Patent Application Publication
(10) Pub. No.: US 2015/0193977 A1
(43) Pub. Date: Jul. 9, 2015

(54) Self-Describing Three-Dimensional (3D) Object Recognition and Control Descriptors for Augmented Reality Interfaces

(71) Applicants: Michael Patrick JOHNSON, Sunnyvale, CA (US); Thad Eugene STARNER, Mountain View, CA (US)

(72) Inventors: Michael Patrick JOHNSON, Sunnyvale, CA (US); Thad Eugene STARNER, Mountain View, CA (US)

(73) Assignee: GOOGLE INC., MOUNTAIN VIEW, CA (US)

(21) Appl. No.: 13/601,058

(22) Filed: Aug. 31, 2012

(51) Int. Cl. G06T 19/00; G06T 15/20; G02B 27/01; G09G 5/00

(52) U.S. Cl. CPC G06T 19/006; G02B 27/017; G06T 15/20

(57) ABSTRACT

Exemplary methods and systems are disclosed that provide for the detection and recognition of target devices, by a mobile computing device, within a pre-defined local environment. An exemplary method may involve (a) receiving, at a mobile computing device, a local-environment message corresponding to a pre-defined local environment that may comprise (i) physical-layout information of the pre-defined local environment or (ii) an indication of a target device located in the pre-defined local environment, (b) receiving image data that is indicative of a field-of-view associated with the mobile computing device, (c) based at least in part on the physical-layout information in the local-environment message, locating the target device in the field-of-view, and (d) causing the mobile computing device to display a virtual control interface for the target device in a location within the field-of-view that is associated with the location of the target device in the field-of-view.

### BACKGROUND

Unless otherwise indicated herein, the materials described in this section are not prior art to the claims in this application and are not admitted to be prior art by inclusion in this section.

Computing devices such as personal computers, laptop computers, tablet computers, cellular phones, and countless types of Internet-capable devices are becoming more and more prevalent in numerous aspects of modern life. As computers become more advanced, augmented-reality devices, which blend computer-generated information with the user's view of the physical world, are expected to become more prevalent.

To provide an augmented-reality experience, location and context-aware mobile computing devices may be used by users as they go about various aspects of their everyday life. Such computing devices are configured to sense and analyze a user's environment, and to intelligently provide information appropriate to the physical world being experienced by the user.

### SUMMARY

An augmented-reality capable device's ability to recognize a user's environment and objects within the user's environment is wholly dependent on vast databases that support the augmented-reality capable device. Currently, in order for an augmented-reality capable device to recognize objects within an environment, the augmented-capable device must know about the objects within the environment, or what databases to search for information regarding the objects within the environment. While more and more mobile computing devices are becoming augmented-reality capable, the databases upon which the mobile computing devices rely still remain limited and non-dynamic.

The methods and systems described herein help provide for the detection and recognition of devices, by a mobile computing device, within a user's pre-defined local environment. These recognition and detection techniques allow target devices within the user's pre-defined local environment to send information about themselves and their location in the pre-defined local environment. In an example embodiment, a target device in a local environment of a wearable mobile computing device having taking the form of a head-mounted display (HMD) broadcasts a local-environment message to a local WiFi router, and upon entry into the pre-defined local environment, the HMD receives the local-environment message. As such, the example methods and systems disclosed herein may help provide the user of the HMD the ability to more dynamically and efficiently determine and recognize an object in the user's pre-defined local environment.

In one aspect, an exemplary method involves: (a) receiving, at a mobile computing device, a local-environment message corresponding to a pre-defined local environment, wherein the local-environment message comprises one or more of: (i) physical-layout information for the pre-defined local environment or (ii) an indication of at least one target device that is located in the pre-defined local environment, (b) receiving image data that is indicative of a field-of-view that is associated with the mobile computing device, (c) based at least in part on the physical-layout information in the local-environment message, locating the at least one target device in the field-of-view, and (d) causing the mobile computing device to display a virtual control interface for the at least one target device in a location within the field-of-view that is associated with the location of the at least one target device in the field-of-view.

In another aspect, a second exemplary method involves: (a) receiving, at a mobile computing device, a local-environment message corresponding to a pre-defined local environment, wherein the pre-defined local environment has at least one target device, and the local-environment message comprises interaction information for the at least one target device in the pre-defined local environment; and (b) based on the local-environment message, causing the mobile computing device to update an interaction data set of the mobile computing device.

In an additional aspect, a non-transitory computer readable medium having instructions stored thereon is disclosed. According to an exemplary embodiment, the instructions include: (a) instructions for receiving a local-environment message corresponding to a pre-defined local environment, wherein the local-environment message comprises one or more of: (i) physical-layout information for the local environment or (ii) an indication of at least one target device that is located in the local environment; (b) instructions for receiving image data that is indicative of a field-of-view that is associated with the mobile computing device; (c) instructions for based at least in part on the physical-layout information in the local-environment message, locating the at least one target device in the field-of-view; and (d) instructions for displaying a virtual control interface for the at least one target device in a location within the field-of-view that is associated with the location of the at least one target device in the field-of-view.

In a further aspect, a second non-transitory computer readable medium having instructions stored thereon is disclosed. According to an exemplary embodiment, the instructions include: (a) instructions for receiving a local-environment message corresponding to a pre-defined local environment, wherein the pre-defined local environment has at least one target device, and the local-environment message comprises interaction information for the at least one target device in the pre-defined local environment; and (b) updating an interaction data set of the mobile computing device.

In yet another aspect, a system is disclosed. An exemplary system includes: (a) a mobile computing device, and (b) instructions stored on the mobile computing device executable by the mobile computing device to perform the functions of: receiving a local-environment message corresponding to a pre-defined local environment, wherein the local-environment message comprises one or more of: (a) physical-layout information for the pre-defined local environment or (b) an indication of at least one target device that is located in the pre-defined local environment, receiving image data that is indicative of a field-of-view that is associated with the mobile computing device, based at least in part on the physical-layout information in the pre-defined local-environment message, locating the at least one target device in the field-of-view, and displaying a virtual control interface for the at least one target device in a location within the field-of-view that is associated with the location of the at least one target device in the field-of-view.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

FIG. 1 is a functional block diagram of a mobile computing device in communication with target devices, in accordance with an example embodiment.

FIG. 2 is a front view of a pre-defined local environment with target devices as perceived by a mobile computing device, in accordance with an example embodiment.

FIG. 3A is a flowchart illustrating a method, in accordance with an example embodiment.

FIG. 3B is a flowchart illustrating another method, in accordance with an example embodiment.

FIG. 4A is a view of a copier in a ready-to-copy state with a superimposed virtual control interface, in accordance with an example embodiment.

FIG. 4B is a view of a copier in an out-of-paper state with a superimposed virtual control interface, in accordance with an example embodiment.

FIG. 4C is a view of a copier in a ready-to-copy state within a pre-defined local environment, in accordance with an example embodiment.

FIG. 5A illustrates a wearable computing device, in accordance with an example embodiment.

FIG. 5B illustrates an alternate view of the wearable computing device illustrated in FIG. 5A.

FIG. 5C illustrates another wearable computing device, in accordance with an example embodiment.

FIG. 5D illustrates another wearable computing device, in accordance with an example embodiment.

FIG. 6 illustrates a schematic drawing of a computing device, in accordance with an example embodiment.

### DETAILED DESCRIPTION

The following detailed description describes various features and functions of the disclosed systems and methods with reference to the accompanying figures. In the figures, similar symbols typically identify similar components, unless context dictates otherwise. The illustrative system and method embodiments described herein are not meant to be limiting. It will be readily understood that certain aspects of the disclosed systems and methods can be arranged and combined in a wide variety of different configurations, all of which are contemplated herein.

Furthermore, the particular arrangements shown in the Figures should not be viewed as limiting. It should be understood that other embodiments may include more or less of each element shown in a given Figure. Further, some of the illustrated elements may be combined or omitted. Yet further, an example embodiment may include elements that are not illustrated in the Figures.

### I. OVERVIEW

Example embodiments disclosed herein relate to a mobile computing device receiving a local-environment message corresponding to a pre-defined local environment, receiving image data that is indicative of a field-of-view that is associated with the mobile computing device, and causing the mobile computing device to display a virtual control interface for a target device in a location within a field-of-view associated with the mobile computing device. Some mobile computing devices may be worn by a user. Commonly referred to as “wearable” computers, such wearable mobile computing devices are configured to sense and analyze a user's environment, and to intelligently provide information appropriate to the physical world being experienced by the user. Within the context of this disclosure, the physical world being experienced by the user wearing a wearable computer is a pre-defined local environment. Such wearable computers may sense and receive image data about the user's pre-defined local environment by, for example, determining the user's location in the environment, using cameras and/or sensors to detect objects near to the user, using microphones and/or sensors to detect what the user is hearing, and using various other sensors to collect information about the pre-defined environment surrounding the user.

In an example embodiment, the wearable computers take the form of a head-mountable display (HMD) that may capture data that is indicative of what the wearer of the HMD is looking at (or would have been looking it, in the event the HMD is not being worn). The data may take the form of or include point-of-view (POV) video from a camera mounted on an HMD. Further, an HMD may include a see-through display (either optical or video see-through), such that computer-generated graphics can be overlaid on the wearer's view of his/her real-world (i.e., physical) surroundings. The HMD may also receive a local-environment message corresponding to the pre-defined local environment of the user. The local-environment message may include physical-layout information of the pre-defined local environment and an indication of target devices (i.e., objects) in the pre-defined local environment. In this configuration, it may be beneficial to display a virtual control interface for a target device in the user's pre-defined local environment at a location in the see through-display. In one example, the virtual control interface aligns with a portion of the real-world object that is visible to the wearer. In other examples, the virtual control interface may align with any portion of the pre-defined local environment that provides a suitable background for the virtual control interface.

To place a suitable virtual control interface for a target object in an HMD, the HMD may evaluate the local-environment message and the visual characteristics of the POV video that is captured at the HMD. For instance, to evaluate a given portion of the POV video, a server system may consider a visual characteristic or characteristics such as the permanence level of real-world objects and/or features relative to the wearer's field of view, the coloration in the given portion, and/or visual pattern in the given portion, and/or the size and shape of the given portion, among other factors. The HMD may use this information along with the information that is provided in the local-environment message to locate the target devices within the pre-defined local environment.

For example, consider a user wearing a HMD that enters an office (i.e., a pre-defined local-environment). The office might include various objects including a desk, scanner, computer, copier, and lamp, for example. Within the context of the disclosure these objects may be known as target devices. Upon entering the office, the user's HMD is waiting to receive data from a broadcasting object or any target devices in the environment. The broadcasting object may be a router, for example. In one instance, the router uploads a local-environment message to the HMD. The HMD now has physical-layout information for the local-environment and/or self-describing information for the scanner, for example. The HMD now knows where to look for the scanner, and upon finding it, the HMD can place information (based on the self-describing data) about the scanner on the HMD in an augmented-reality manner. The information may include, for example, a virtual control interface that displays information about the target device. In other examples, the virtual control interface may allow the HMD to control the target device.

While the foregoing example illustrates the HMD cacheing the local-environment message (i.e., storing it on a memory device of the HMD), in another embodiment, a local WiFi router of the environment may also cache the local-environment message. Referring to the office example above, the local WiFi router has the local-environment message received from the scanner (received, for example, when the scanner connected to the WiFi network) stored. The HMD pulls this information as the user walks into the office, and uses it as explained above. Other examples are also possible. Note that in the above referenced example, receiving a local-environment message helped the HMD to identify target objects within the pre-defined local environment in a dynamic and efficient manner.

In other embodiments the mobile computing device may take the form of a smartphone or a tablet, for example. Similar to the foregoing wearable computer example, the smartphone or tablet may collect information about the environment surrounding a user, analyze that information, and determine what information, if any, should be presented to the user in an augmented-reality manner.

### II. EXAMPLE SYSTEMS

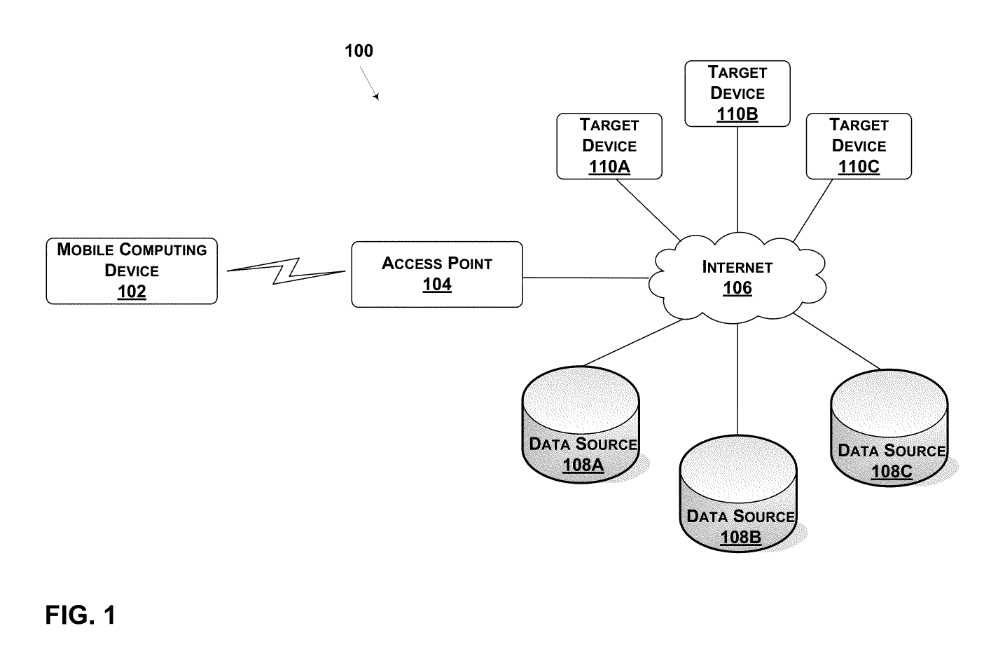

FIG. 1 is a simplified block diagram illustrating a system in which a mobile computing device communicates with self-describing target devices in a pre-defined local environment. As shown, the network 100 includes an access point 104, which provides access to the Internet 106. Provided with access to the Internet 106 via access point 104, mobile computing device 102 can communicate with the various target objects 110a-c, as well as various data sources 108a-c, if necessary.

The mobile computing device 102 may take various forms, and as such, may incorporate various display types to provide an augmented-reality experience. In an exemplary embodiment, mobile computing device 102 is a wearable mobile computing device and includes a head-mounted display (HMD). For example, wearable mobile computing device 102 may include an HMD with a binocular display or a monocular display. Additionally, the display of the HMD may be, for example, an optical see-through display, an optical see-around display, or a video see-through display. More generally, the wearable mobile computing device 102 may include any type of HMD configured to provide an augmented-reality experience to its user.

In order to sense the environment and experiences of the user, wearable mobile computing device 102 may include or be provided with input from various types of sensing and tracking devices. Such devices may include video cameras, still cameras, Global Positioning System (GPS) receivers, infrared sensors, optical sensors, biosensors, Radio Frequency identification (RFID) systems, wireless sensors, accelerometers, gyroscopes, and/or compasses, among others.

In other example embodiments, the mobile computing device comprises a smartphone or a tablet. Similar to the previous embodiment, the smartphone or tablet enables the user to observe his/her real-world surroundings and also view a displayed image, such as a computer-generated image. The user holds the smartphone or the tablet, showing the real world combined with the overlaid computer generated images. In some cases, the displayed image may overlay a portion of the user's smartphone's or tablet's display screen. Thus, while the user of the smartphone or tablet is going about his/her daily activities, such as working, walking, reading, or playing games, the user may be able to see a displayed image generated by the smartphone or tablet at the same time that the user is looking out at his/her real-world surroundings through the display of the smartphone or tablet.

In other illustrative embodiments, the mobile computing device may take the form of a portable media device, personal digital assistant, notebook computer, or any other mobile device capable of capturing images of the real-world and generating images or other media content that is to be displayed to the user.

Access point 104 may take various forms, depending upon which protocol mobile computing device 102 uses to connect to the Internet 106. For example, in one embodiment, if mobile computing device 102 connects using 802.11 or via an Ethernet connection, access point 104 may take the form of a wireless access point (WAP) or wireless router. As another example, if mobile computing device 102 connects using a cellular air-interface protocol, such as a CDMA or GSM protocol, then access point 104 may be a base station in a cellular network, which provides Internet connectivity via the cellular network. Further, since mobile computing device 102 may be configured to connect to Internet 106 using multiple wireless protocols, it is also possible that mobile computing device 102 may be configured to connect to the Internet 106 via multiple types of access points.

Mobile computing device 102 may be further configured to communicate with a target device that is located in the user's pre-defined local environment. In order to communicate with the wireless router or the mobile computing device, the target devices 110a-c may include a communication interface that allows the target device to upload information about itself to the Internet 106. In one example, the mobile computing device 102 may receive information about the target device 110a from a local wireless router that received information from the target device 110a via WiFi. The target devices 110a-c may use other means of communication, such as Bluetooth for example. In other embodiments, the target devices 110a-c may also communicate directly with the mobile computing device 102.

The target devices 110a-c could be any electrical, optical, or mechanical device. For example, the target device 110a could be a home appliance, such as an espresso maker, a television, a garage door, an alarm system, an indoor or outdoor lighting system, or an office appliance, such as a copy machine. The target devices 110a-c may have existing user interfaces that may include, for example, buttons, a touch screen, a keypad, or other controls through which the target devices may receive control instructions or other input from a user. The target devices 110a-c's existing user interfaces may also include a display, indicator lights, a speaker, or other elements through which the target device may convey operating instructions, status information, or other output to the user. Alternatively, the target devices may have no outwardly visible user interface such as a refrigerator or a desk lamp, for example.

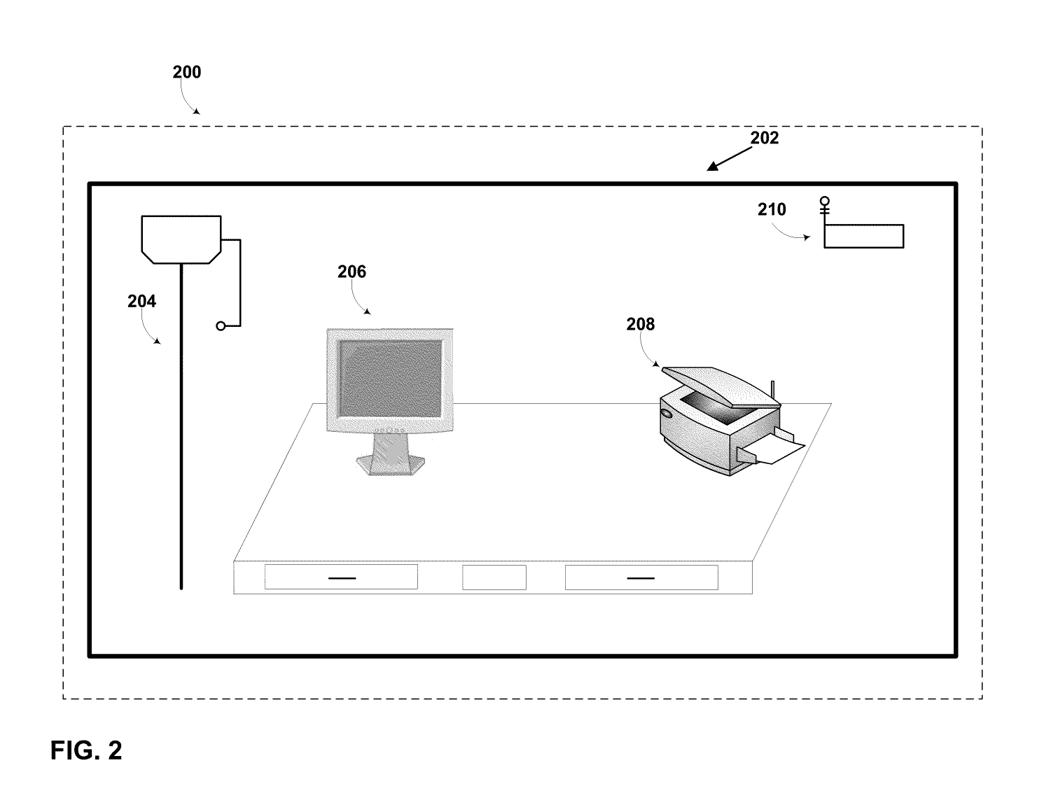

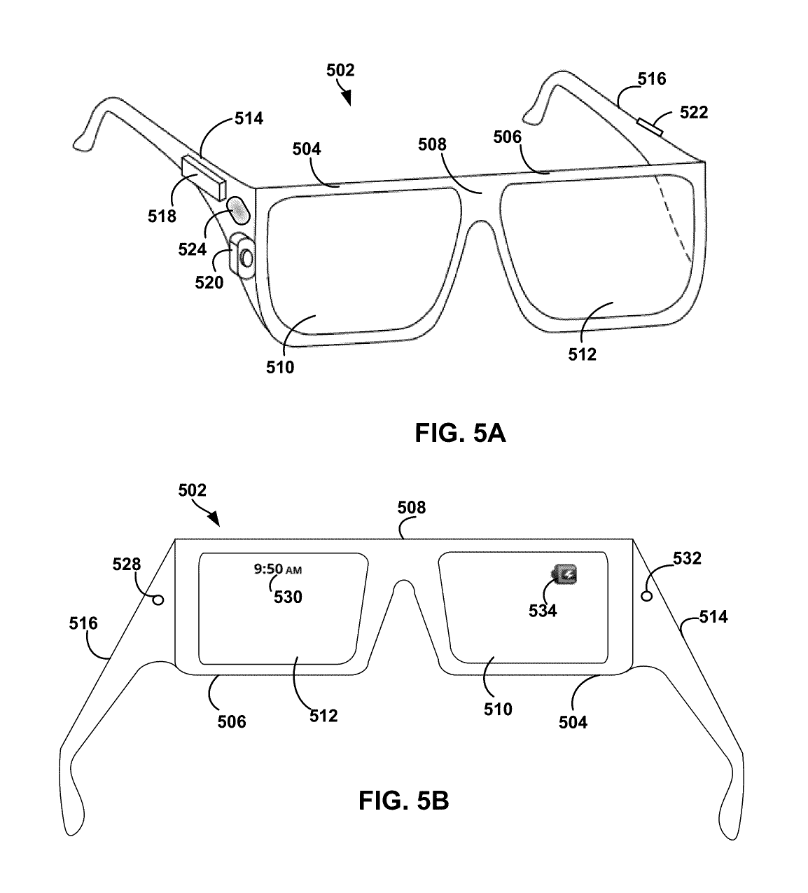

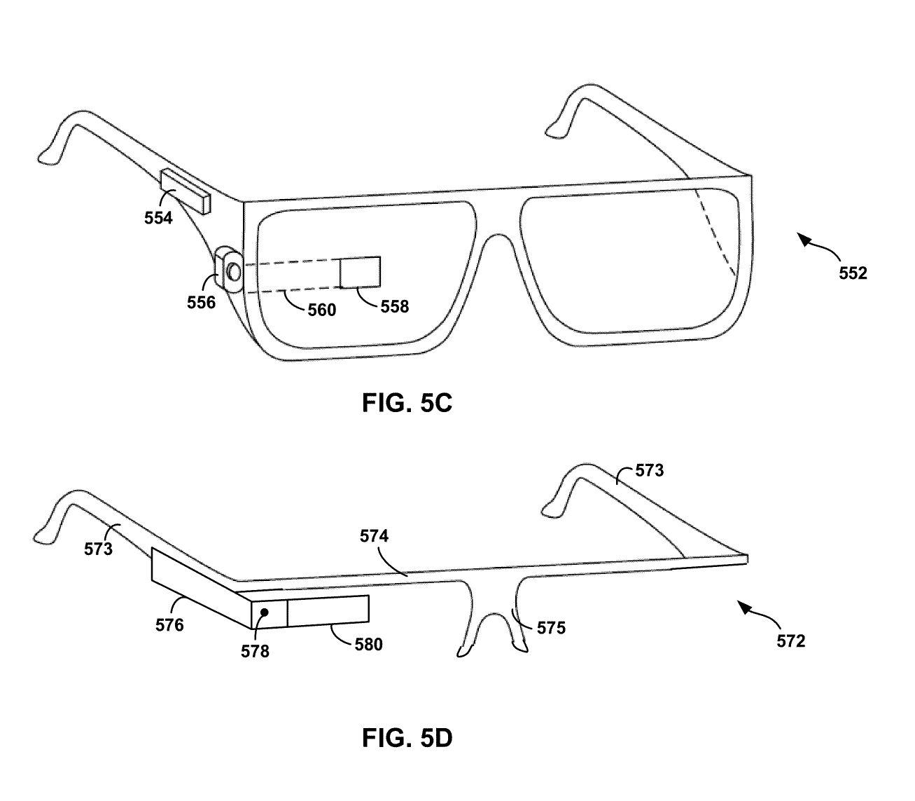

FIG. 2 is an illustration of an exemplary pre-defined local environment. As shown, pre-defined local-environment 200 is an office that includes a lamp 204, a computer 206, a copier 208, and a wireless router 210. This pre-defined local environment 200 may be perceived by a user wearing the HMD described in FIGS. 5A-5D, for example. For instance, as the user enters the pre-defined local environment 200 (i.e., the office), he/she may view the office from a horizontal, forward facing view-point. As the user perceives the pre-defined local environment 200 through the HMD, the HMD may create a field-of-view 202 associated with the pre-defined local environment. In the pre-defined local environment 200, the lamp 204, computer 206, and copier 208 are all target devices that may communicate with the mobile computing device. Such communication may occur directly or via wireless router 210, for example.

### III. EXAMPLE METHODS

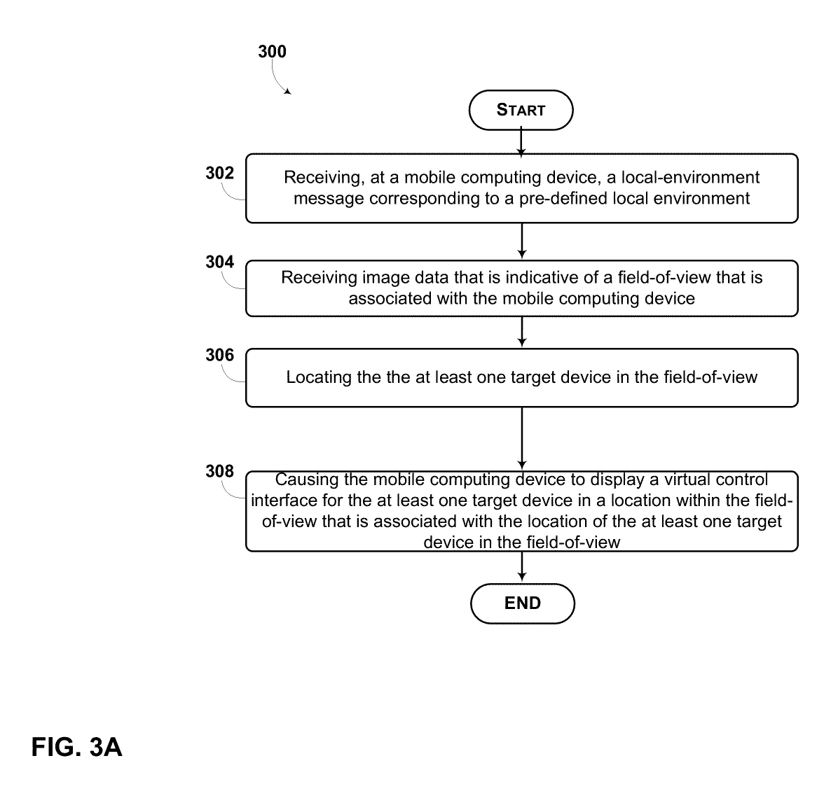

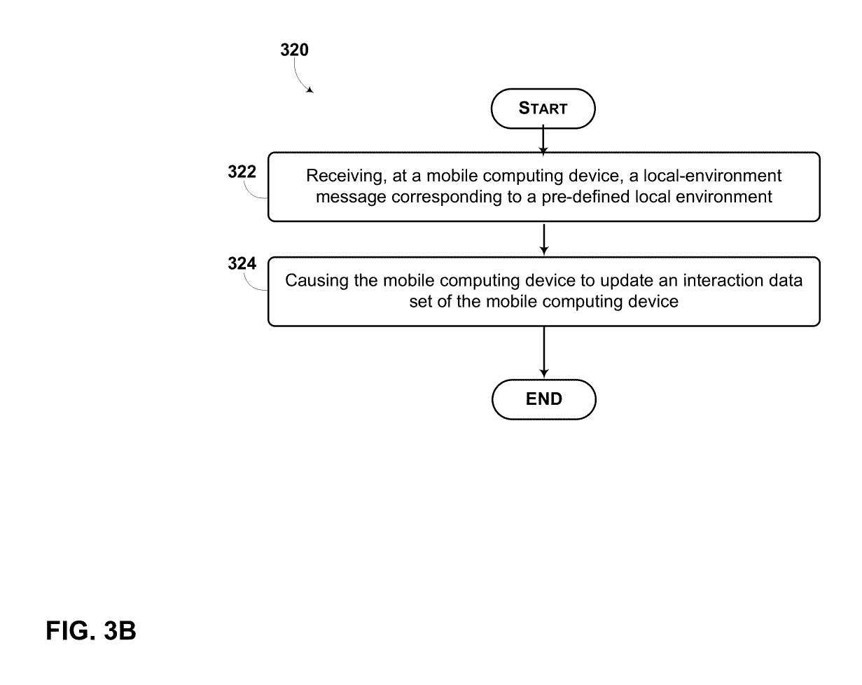

FIG. 3A is a flow chart illustrating a method 300 according to an exemplary embodiment. Method 300 is described by way of example as being carried out by a mobile computing device taking the form of a wearable computing device having an HMD. However, it should be understood that an exemplary method may be carried out by any type of mobile computing device, by one or more other entities in communication with a mobile computing device via a network (e.g., in conjunction with or with the assistance of an augmented-reality server), or by a mobile computing device in combination with one or more other entities. Method 300 will be described by reference to FIG. 2.

As shown by block 302, method 300 involves a mobile computing device receiving a local-environment message corresponding to a pre-defined local environment. The local-environment message comprises one or more of: (a) physical-layout information for the local environment or (b) an indication of at least one target device that is located in the pre-defined local environment. The mobile computing device then receives image data that is indicative of a field-of-view that is associated with the mobile computing device. Next, based at least in part on the physical-layout information in the local-environment message, the mobile computing device locates the at least one target device in the field-of-view. The mobile computing device then displays a virtual control interface for the at least one target device in a location within the field-of-view that is associated with the location of the at least one target device in the field-of-view.

For example, a user wearing a HMD may enter an office looking to make copies. The office might include a lamp 204, a computer 206, a copier 208, and a local wireless router 210 such as those illustrated in FIG. 2. Within the context of this example, the lamp 204, the computer 206, and the copier 208 are target devices, and may each connect to the wireless router 210 and upload a local-environment message. In other examples, the target devices may connect to the internet via the wireless router and upload the local-environment message to any location based service system. The local-environment message may include physical-layout information for the pre-defined local environment and an indication that at least one target device (e.g., the lamp, computer, or copier) is located in the pre-defined local environment, for example. The physical-layout information may include location information about the target device (e.g., the lamp, computer, or copier) in the pre-defined local environment, a description of the pre-defined local environment (office), data defining a three-dimensional (3D) model of the pre-defined local environment, data defining a two-dimensional (2D) view of the pre-defined local environment, and a description of the pre-defined local environment, for example. The target device indication may include data comprising data defining a 3D model of the target device, data defining a 2D view of the target device, control inputs and outputs for the target device, control instructions for the target device, and a description of the target device, for example. Other information may be included in the local-environment message.

As the user wearing the HMD enters the office (shown as 200 in FIG. 2), the local wireless router 210 may already know about the active target devices within the office that may communicate with the user's HMD. Upon entering the office, the HMD of the user obtains the location-environment message that includes information about the target device(s)—lamp 204, computer 206, and/or copier 208—from the wireless router 210, and stores a local copy of the location-environment message on the computing system of the HMD. In other examples, the HMD of the user may obtain the location-environment message from any location based service system or database that already knows about the active target devices within the office.

After receiving the local-environment message, the HMD may receive image data that is indicative of a field-of-view of the HMD. For example, the HMD may receive image data of the office 200. The image data may include images and video of the target devices 204, 206, and 208, for example. The image data may also be restricted to the field-of-view 202 associated with the HMD, for example. The image data may further include other things in the office that are not target devices, and do not communicate with the HMD like the desk (not numbered), for example.

Once the HMD has received image data relating to a field-of view of the HMD, the user, using the HMD, may locate the target devices in the office and in the field-of view of the HMD. For example, the target device may be located based, at least in part on the physical-layout information of the location-environment message. To do so, the HMD may use the data defining the 3D model of the pre-defined local environment, data defining the 2D view of the pre-defined local environment, and the description of the pre-defined local environment to locate an area of the target device, for example. After locating an area of the target device the HMD may locate the target device within the field-of-view of the HMD. The HMD may also use the field-of-view image data and compare it to the data (indication information of the local-environment message) defining the 3D model of the target device, data defining the 2D views of the target device, and the description of the target device to facilitate the identification and location of the target device, for example. Some or all of the information in the location-environment message may be used.

To locate (and identify) the target device, in one embodiment, the HMD may compare the field-of-view image data obtained by the HMD to the data defining the 3D model of the target device to locate and select the target device that is most similar to the 3D model. Similarity may be determined based on, for example, a number or configuration of the visual features (e.g., colors, shapes, textures, depths, brightness levels, etc.) in the target device (or located area) and in the provided data (i.e., in the 3D model representing the target device). For example, a histogram of oriented gradients technique may be used (e.g., as described in “Histogram of Oriented Gradients,” Wikipedia, (Feb. 15, 2012), http://en.wikipedia.org/wiki/Histogram_of_oriented_gradients) to identify the target device, in which the provided 3D model is described by a histogram (e.g., of intensity gradients and/or edge directions), and the image data of the target device (or the area that includes the target device) is described by a histogram. A similarity may be determined based on the histograms. Other techniques are possible as well.

Once the copier 208 is located and identified, a virtual control interface for the copier 208 may be may be displayed in a field-of-view of the HMD. The virtual control interface may be displayed in the field-of-view of the HMD and be associated with the location of the copier 208, for example. In some embodiments, the virtual control interface is superimposed over the copier (i.e., target device). The virtual control interface may include control inputs and outputs for the copier 208, as well as operating instructions for the copier 208, for example. The virtual control interface may further include status information for the copier, for example. The user may receive instructions that the copier 208 is “out of paper,” or instructions on how the user should load paper and make a copy, for example. In other examples, once the virtual control interface is displayed, the user may physically interact with the virtual control interface to operate the target device. For example, the user may interact with the virtual control interface of the copier 208 to make copies. In this example, the virtual control interface may not be superimposed over the copier 208.

FIG. 3B is a flow chart illustrating another method 320 according to an exemplary embodiment. As shown by block 322, method 320 involves a mobile computing device receiving a local-environment message corresponding to a pre-defined local environment. The local environment message includes interaction information for the at least one target device in the pre-defined local environment. The local-environment message comprises interaction information for the at least one target device in the pre-defined local environment. The mobile computing device then based on the local environment message, updates an interaction data set of the mobile computing device.

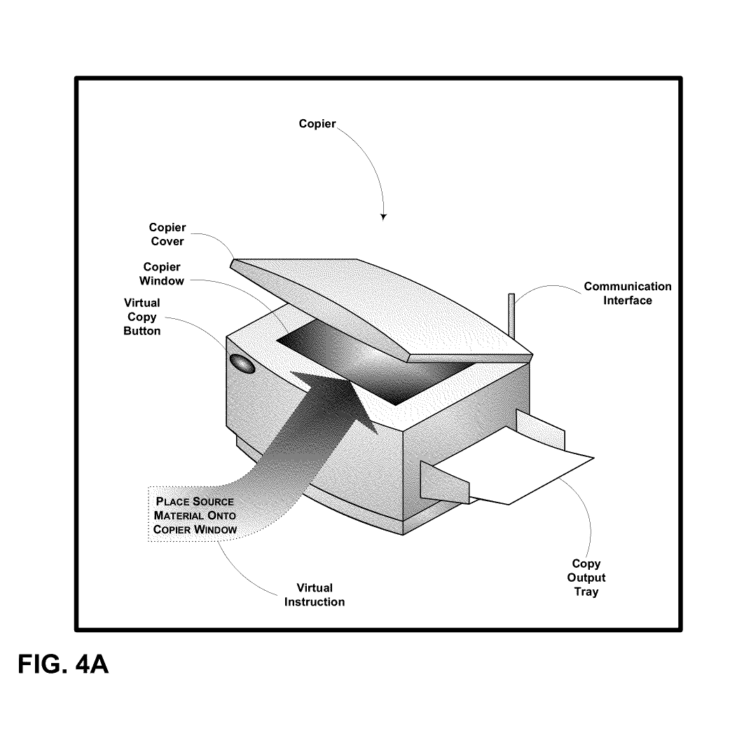

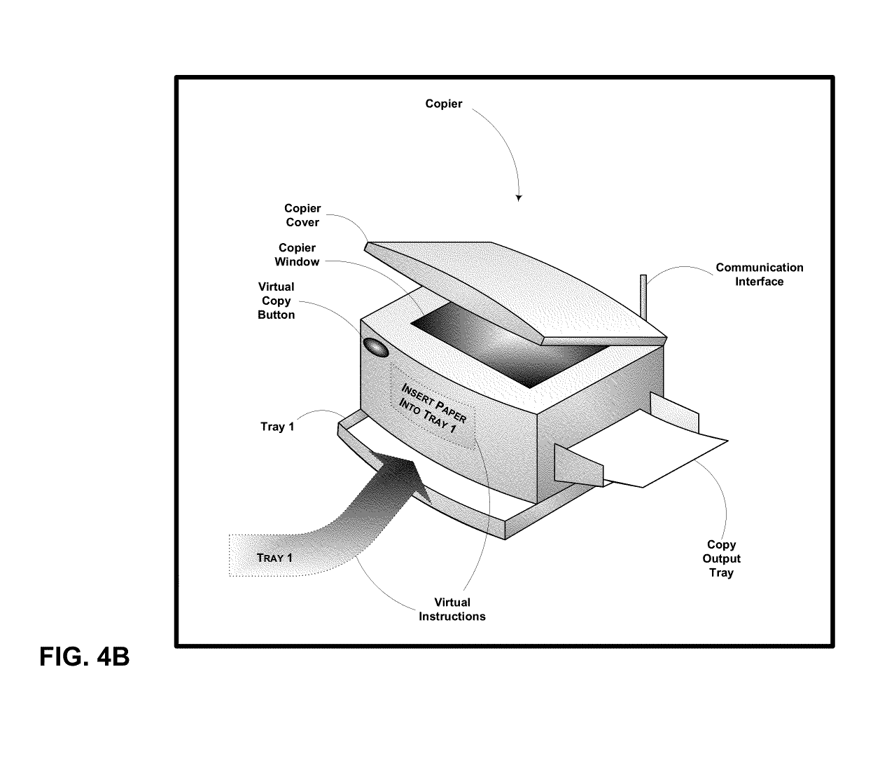

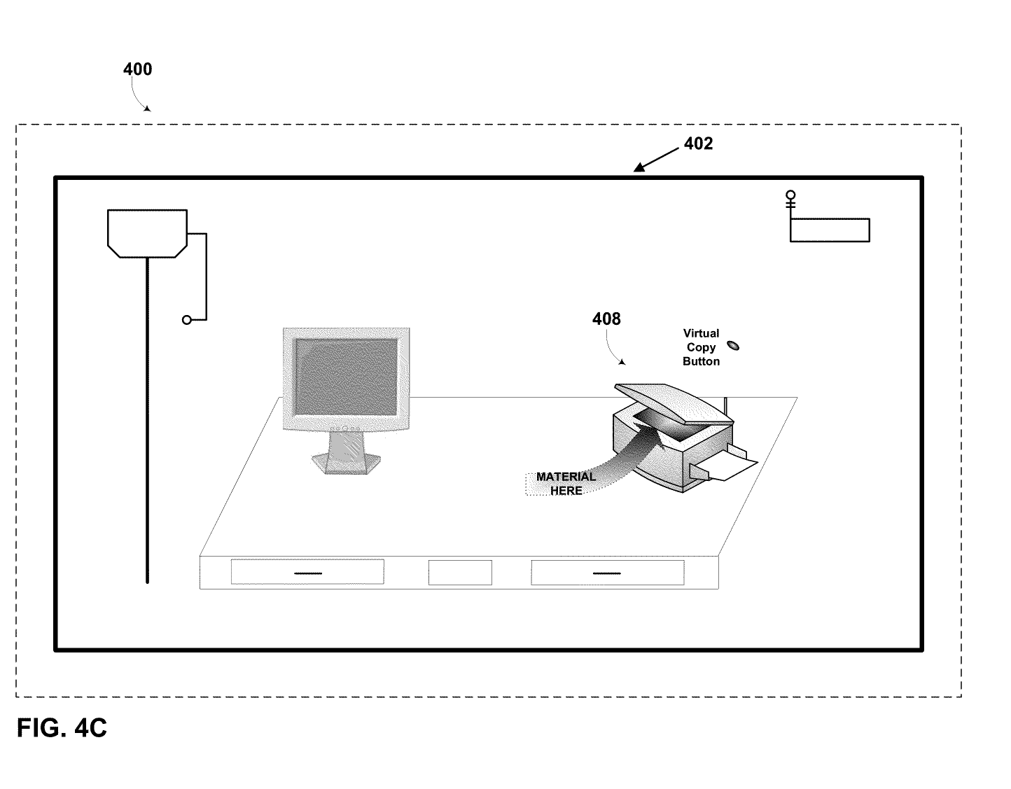

FIGS. 4A and 4B illustrate how a virtual control interface may be provided for a copier, in accordance with the operational state of the copier. FIG. 4A illustrates an example in which the copier is in a ready-to-copy state, an operational state that the copier may indicate to the HMD in the local-environment message. In this operational state, the virtual control interface may include a virtual copy button and virtual text instruction. The virtual copy button may be actuated for example, by a gesture or by input through a user interface of the wearable computing device to cause the copier to make a copy. For instance, speech may be used as one means to interface with wearable computing device. The HMD may recognize the actuation of the virtual copy button as a copy instruction and communicate the copy instruction to the copier. The virtual text instruction includes the following text: “PLACE SOURCE MATERIAL ONTO COPIER WINDOW” within an arrow that indicates the copier window. In other examples, the virtual control interface may not actuate instructions and my simply provide status information to the user.

FIG. 4B illustrates an example in which the copier is in an out-of-paper state. When the copier is out of paper, the copier may also communicate this operational state to the HMD device using the local-environment message. In response, the HMD may adjust the virtual control interface to display different virtual instructions. As shown in FIG. 4B, the virtual instructions may include the following text displayed on the copier housing: “INSERT PAPER INTO TRAY 1” and the text “TRAY 1” in an arrow that indicates Tray 1.

FIG. 4C illustrates an exemplary pre-defined local environment 400, similar to FIG. 2, but later in time. FIG. 4C illustrates the pre-defined local environment after the user's HMD has pulled the local-environment message and located the relevant target-device, here the copier 408. As shown in the Figure, copier 408 is in a ready-to-copy state, with a virtual control interface being displayed within the field-of-view 402. In this embodiment, the copy control button is displayed within the field-of-view and associated with copier 408, but not superimposed over the copier 408.

It is to be understood that the virtual control interfaces illustrated in FIGS. 4A-4C are merely examples. In other examples, the virtual control interfaces for a copier may include other and/or additional virtual control buttons, virtual instructions, or virtual status indicators. In addition, although two operational states are illustrated in FIGS. 4A and 4B (ready-to-copy and out-of-paper), it is to be understood that a mobile computing device may display virtual control interfaces for a greater or fewer number of operational states. In addition, it should be understood that the virtual control interface for a target device, such as a copier, might not be responsive to the target device's operational state at all.

Systems and devices in which exemplary embodiments may be implemented will now be described in greater detail. In general, an exemplary system may be implemented in or may take the form of a wearable computer. However, an exemplary system may also be implemented in or take the form of other devices, such as a mobile smartphone, among others. Further, an exemplary system may take the form of non-transitory computer readable medium, which has program instructions stored thereon that are executable by a processor to provide the functionality described herein. An exemplary system may also take the form of a device such as a wearable computer or mobile phone, or a subsystem of such a device, which includes such a non-transitory computer readable medium having such program instructions stored thereon.

### IV. EXEMPLARY WEARABLE COMPUTING DEVICES

FIG. 5A illustrates a wearable computing system according to an exemplary embodiment. In FIG. 5A, the wearable computing system takes the form of a head-mounted display (HMD) 502 (which may also be referred to as a head-mounted device). It should be understood, however, that exemplary systems and devices may take the form of or be implemented within or in association with other types of devices, without departing from the scope of the invention. As illustrated in FIG. 5A, the head-mounted device 502 comprises frame elements including lens-frames 504, 506 and a center frame support 508, lens elements 510, 512, and extending side-arms 514, 516. The center frame support 508 and the extending side-arms 514, 516 are configured to secure the head-mounted device 502 to a user's face via a user's nose and ears, respectively.

Each of the frame elements 504, 506, and 508 and the extending side-arms 514, 516 may be formed of a solid structure of plastic and/or metal, or may be formed of a hollow structure of similar material so as to allow wiring and component interconnects to be internally routed through the head-mounted device 502. Other materials may be possible as well.

One or more of each of the lens elements 510, 512 may be formed of any material that can suitably display a projected image or graphic. Each of the lens elements 510, 512 may also be sufficiently transparent to allow a user to see through the lens element. Combining these two features of the lens elements may facilitate an augmented reality or heads-up display where the projected image or graphic is superimposed over a real-world view as perceived by the user through the lens elements.

The extending side-arms 514, 516 may each be projections that extend away from the lens-frames 504, 506, respectively, and may be positioned behind a user's ears to secure the head-mounted device 502 to the user. The extending side-arms 514, 516 may further secure the head-mounted device 502 to the user by extending around a rear portion of the user's head. Additionally or alternatively, for example, the HMD 502 may connect to or be affixed within a head-mounted helmet structure. Other possibilities exist as well.

The HMD 502 may also include an on-board computing system 518, a video camera 520, a sensor 522, and a finger-operable touch pad 524. The on-board computing system 518 is shown to be positioned on the extending side-arm 514 of the head-mounted device 502; however, the on-board computing system 518 may be provided on other parts of the head-mounted device 502 or may be positioned remote from the head-mounted device 502 (e.g., the on-board computing system 518 could be wire- or wirelessly-connected to the head-mounted device 502). The on-board computing system 518 may include a processor and memory, for example. The on-board computing system 518 may be configured to receive and analyze data from the video camera 520 and the finger-operable touch pad 524 (and possibly from other sensory devices, user interfaces, or both) and generate images for output by the lens elements 510 and 512.

The video camera 520 is shown positioned on the extending side-arm 514 of the head-mounted device 502; however, the video camera 520 may be provided on other parts of the head-mounted device 502. The video camera 520 may be configured to capture images at various resolutions or at different frame rates. Many video cameras with a small form-factor, such as those used in cell phones or webcams, for example, may be incorporated into an example of the HMD 502.

Further, although FIG. 5A illustrates one video camera 520, more video cameras may be used, and each may be configured to capture the same view, or to capture different views. For example, the video camera 520 may be forward facing to capture at least a portion of the real-world view perceived by the user. This forward facing image captured by the video camera 520 may then be used to generate an augmented reality where computer generated images appear to interact with the real-world view perceived by the user.

The sensor 522 is shown on the extending side-arm 516 of the head-mounted device 502; however, the sensor 522 may be positioned on other parts of the head-mounted device 502. The sensor 522 may include one or more of a gyroscope or an accelerometer, for example. Other sensing devices may be included within, or in addition to, the sensor 522 or other sensing functions may be performed by the sensor 522.

The finger-operable touch pad 524 is shown on the extending side-arm 514 of the head-mounted device 502. However, the finger-operable touch pad 524 may be positioned on other parts of the head-mounted device 502. Also, more than one finger-operable touch pad may be present on the head-mounted device 502. The finger-operable touch pad 524 may be used by a user to input commands. The finger-operable touch pad 524 may sense at least one of a position and a movement of a finger via capacitive sensing, resistance sensing, or a surface acoustic wave process, among other possibilities. The finger-operable touch pad 524 may be capable of sensing finger movement in a direction parallel or planar to the pad surface, in a direction normal to the pad surface, or both, and may also be capable of sensing a level of pressure applied to the pad surface. The finger-operable touch pad 524 may be formed of one or more translucent or transparent insulating layers and one or more translucent or transparent conducting layers. Edges of the finger-operable touch pad 524 may be formed to have a raised, indented, or roughened surface, so as to provide tactile feedback to a user when the user's finger reaches the edge, or other area, of the finger-operable touch pad 524. If more than one finger-operable touch pad is present, each finger-operable touch pad may be operated independently, and may provide a different function.

FIG. 5B illustrates an alternate view of the wearable computing device illustrated in FIG. 5A. As shown in FIG. 5B, the lens elements 510, 512 may act as display elements. The head-mounted device 502 may include a first projector 528 coupled to an inside surface of the extending side-arm 516 and configured to project a display 530 onto an inside surface of the lens element 512. Additionally or alternatively, a second projector 532 may be coupled to an inside surface of the extending side-arm 514 and configured to project a display 534 onto an inside surface of the lens element 510.

The lens elements 510, 512 may act as a combiner in a light projection system and may include a coating that reflects the light projected onto them from the projectors 528, 532. In some embodiments, a reflective coating may not be used (e.g., when the projectors 528, 532 are scanning laser devices).

In alternative embodiments, other types of display elements may also be used. For example, the lens elements 510, 512 themselves may include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver may be disposed within the frame elements 504, 506 for driving such a matrix display. Alternatively or additionally, a laser or LED source and scanning system could be used to draw a raster display directly onto the retina of one or more of the user's eyes. Other possibilities exist as well.

FIG. 5C illustrates another wearable computing system according to an exemplary embodiment, which takes the form of an HMD 552. The HMD 552 may include frame elements and side-arms such as those described with respect to FIGS. 1A and 1B. The HMD 552 may additionally include an on-board computing system 554 and a video camera 556, such as those described with respect to FIGS. 5A and 5B. The video camera 556 is shown mounted on a frame of the HMD 552. However, the video camera 556 may be mounted at other positions as well.

As shown in FIG. 5C, the HMD 552 may include a single display 558 which may be coupled to the device. The display 558 may be formed on one of the lens elements of the HMD 552, such as a lens element described with respect to FIGS. 5A and 5B, and may be configured to overlay computer-generated graphics in the user's view of the physical world. The display 558 is shown to be provided in a center of a lens of the HMD 552, however, the display 558 may be provided in other positions. The display 558 is controllable via the computing system 554 that is coupled to the display 558 via an optical waveguide 560.

FIG. 5D illustrates another wearable computing system according to an exemplary embodiment, which takes the form of an HMD 572. The HMD 572 may include side-arms 573, a center frame support 574, and a bridge portion with nosepiece 575. In the example shown in FIG. 5D, the center frame support 574 connects the side-arms 573. The HMD 572 does not include lens-frames containing lens elements. The HMD 572 may additionally include an on-board computing system 576 and a video camera 578, such as those described with respect to FIGS. 5A and 5B.

The HMD 572 may include a single lens element 580 that may be coupled to one of the side-arms 573 or the center frame support 574. The lens element 580 may include a display such as the display described with reference to FIGS. 5A and 5B, and may be configured to overlay computer-generated graphics upon the user's view of the physical world. In one example, the single lens element 580 may be coupled to the inner side (i.e., the side exposed to a portion of a user's head when worn by the user) of the extending side-arm 573. The single lens element 580 may be positioned in front of or proximate to a user's eye when the HMD 572 is worn by a user. For example, the single lens element 180 may be positioned below the center frame support 574, as shown in FIG. 5D.

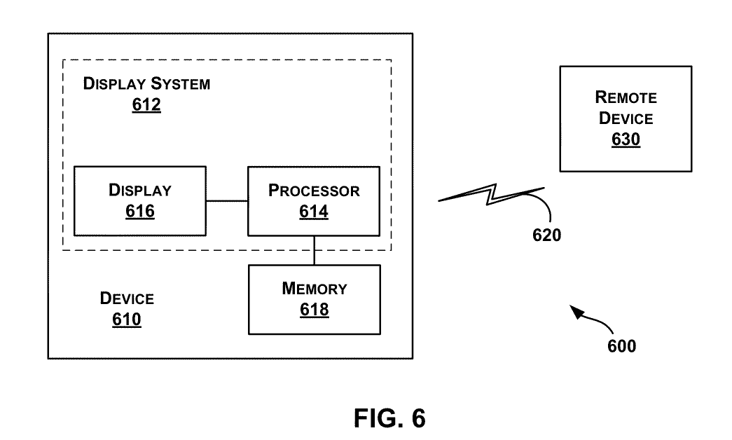

FIG. 6 illustrates a schematic drawing of a computing device according to an exemplary embodiment. In system 600, a device 610 communicates using a communication link 620 (e.g., a wired or wireless connection) to a remote device 630. The device 610 may be any type of device that can receive data and display information corresponding to or associated with the data. For example, the device 610 may be a heads-up display system, such as the head-mounted devices 502, 552, or 572 described with reference to FIGS. 5A-5D.

Thus, the device 610 may include a display system 612 comprising a processor 614 and a display 616. The display 616 may be, for example, an optical see-through display, an optical see-around display, or a video see-through display. The processor 614 may receive data from the remote device 630, and configure the data for display on the display 616. The processor 614 may be any type of processor, such as a micro-processor or a digital signal processor, for example.

The device 610 may further include on-board data storage, such as memory 618 coupled to the processor 614. The memory 618 may store software that can be accessed and executed by the processor 614, for example.

The remote device 630 may be any type of computing device or transmitter including a laptop computer, a mobile telephone, or tablet computing device, etc., that is configured to transmit data to the device 610. The remote device 630 and the device 610 may contain hardware to enable the communication link 620, such as processors, transmitters, receivers, antennas, etc.

In FIG. 6, the communication link 620 is illustrated as a wireless connection; however, wired connections may also be used. For example, the communication link 620 may be a wired serial bus such as a universal serial bus or a parallel bus. A wired connection may be a proprietary connection as well. The communication link 620 may also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 630 may be accessible via the Internet and may include a computing cluster associated with a particular web service (e.g., social-networking, photo sharing, address book, etc.).

### V. CONCLUSION

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method comprising:
receiving, at a mobile computing device, local-environment information corresponding to a local environment, the local-environment information indicating at least one target device that is located in the defined local environment, the local-environment information including three-dimensional (3D) object data describing the at least one target device, the 3D object data being communicated by the at least one target device to identify itself in the local environment;
determining a field-of-view image associated with a field of view of the mobile computing device;
identifying the at least one target device in the field-of-view image based at least in part on the 3D object data; and
displaying the field-of-view image including a virtual control interface for the at least one target device, the virtual control interface being displayed according to the position of the at least one target device in the field-of-view image.

2. The method of claim 1, wherein the mobile computing device is wearable and includes a head-mounted display (HMD).

3. The method of claim 1, wherein the local-environment information further includes physical-layout information, the physical-layout information including one or more of: a location of the at least one target device in the local environment, data defining at least one three-dimensional (3D) model of the local environment, data defining at least one two-dimensional (2D) view of the local environment, or a description of the local environment.

4. The method of claim 1, wherein the 3D object data includes one or more of data defining at least one 3D model of the at least one target device, or data defining at least one 2D view of the at least one target device.

5. The method of claim 3, wherein identifying the at least one target device in the field-of-view image includes comparing the 3D object data and the physical-layout information.

6. The method of claim 1, wherein the local-environment information further includes one or more of: control inputs and outputs for the at least one target device, or control instructions for the at least one target device, and
the virtual control interface is defined at least in part based on one or more of: the control inputs and outputs of the at least one target device, or the control instructions for the at least one target device.

7. The method of claim 1, wherein receiving, at the mobile computing device, the local-environment information includes receiving the local-environment information from a wireless device in the local environment.

8. The method of claim 1, wherein receiving, at the mobile computing device, the local-environment information includes receiving the local-environment information from the at least one target device.

9-13. (canceled)

14. A non-transitory computer readable medium having instructions stored thereon, the instructions comprising:
instructions for receiving local-environment information corresponding to a local environment, the local-environment information indicating at least one target device that is located in the local environment, the local-environment information including three-dimensional (3D) object data describing the at least one target device, the 3D object data being communicated by the at least one target device to identify itself in the local environment;
instructions for determining a field-of-view associated with a field of view of the mobile computing device;
instructions for identifying the at least one target device in the field-of-view image based at least in part on the 3D object data; and
instructions for displaying the field-of view image including a virtual control interface for the at least one target device, the virtual control interface being displayed according to the position of the at least one target device in the field-of-view image.

15. The non-transitory computer readable medium of claim 14, wherein the local-environment information further includes physical-layout information, the physical-layout information including one or more of a location of: the at least one target device in the local environment, data defining at least one three-dimensional (3D) model of the local environment, data defining at least one two-dimensional (2D) view of the local environment, or a description of the local environment.

16. The non-transitory computer readable medium of claim 14, wherein the 3D object data includes one or more of: data defining at least one 3D model of the at least one target device, or data defining at least one 2D view of the at least one target device.

17. The non-transitory computer readable medium of claim 15, wherein the instructions for identifying the at least one target device in the field-of-view image include instructions for comparing the 3D object data and the physical-layout information.

18. The non-transitory computer readable medium of claim 14, wherein the local-environment information further includes one or more of: control inputs and outputs for the at least one target device, or control instructions for the at least one target device, and
the virtual control interface is defined based at least in part on one or more of: the control inputs and outputs of the at least one target device, or the control instructions for the at least one target device.

19. The non-transitory computer readable medium of claim 14, wherein the instructions for receiving the local-environment information includes instructions for receiving the local-environment information from a wireless device in the local environment.

20. The non-transitory computer readable medium of claim 14, wherein the instructions for receiving the local-environment information includes instructions for receiving the local-environment information from the at least one target device.

21-24. (canceled)

25. A system comprising:
a mobile computing device; and
instructions stored on the mobile computing device executable by the mobile computing device to perform the functions of:
receiving local-environment information corresponding to a local environment, the local-environment information indicating at least one target device that is located in the local environment, the local-environment information including three-dimensional (3D) object data describing the at least one target device, the 3D object data being communicated by the at least one target device to identify itself in the local environment;
determining a field-of-view image associated with a field of view of the mobile computing device;
identifying the at least one target device in the field-of-view image based at least in part on the 3D object data; and
displaying the field-of-view image including a virtual control interface for the at least one target device, the virtual control interface being displayed according to the position of the at least one target device in the field-of-view image.

26. The system of claim 25, wherein the mobile computing device is wearable and includes a head-mounted display (HMD).

27. The system of claim 25, wherein the local-environment information further includes physical-layout information, the physical-layout information including one or more of: a location of the at least one target device in the local environment, data defining at least one three-dimensional (3D) model of the local environment, data defining at least one two-dimensional (2D) view of the local environment, or a description of the local environment.

28. The system of claim 27, wherein identifying the at least one target device in the field-of-view image includes comparing the 3D object data and the physical layout information.

29. The system of claim 25, wherein the 3D object data includes one or more of: data defining at least one 3D model of the at least one target device, or data defining at least one 2D view of the at least one target device.

30. The system of claim 25, wherein the local-environment information further includes one or more of: control inputs and outputs for the at least one target device, or control instructions for the at least one target device, and
the virtual control interface is defined at least in part based on one or more of: the control inputs and outputs of the at least one target device, or the control instructions for the at least one target device.

31. The system of claim 25, wherein receiving, at the mobile computing device, the local-environment information includes receiving the local-environment information from a wireless device in the local environment.

32. The system of claim 25, wherein receiving, at the mobile computing device, the local-environment information includes receiving the local-environment information from the at least one target device.
